(19) United States
(12) Patent Application Publication
(10) Pub. No.: US 2026/0204824 A1
(43) Pub. Date: Jul. 16, 2026

(54) CABLE CONNECTOR WITH IMPROVED CONDUCTIVE TERMINALS

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/448,426

(22) Filed: Jan. 14, 2026

(30) Foreign Application Priority Data
Jan. 14, 2025 (CN) 202510058606.9

(51) Int. Cl. H01R 13/20; H01R 13/11

(52) U.S. Cl. CPC H01R 13/20; H01R 13/111

(57) ABSTRACT

A cable connector includes: an insulating shell; two conductive members each having a receiving hole opening forwards and connecting with a cable respectively; and two conductive terminals assembled in the receiving holes respectively, each conductive terminal including a ring base defining a circumferential direction, a radial direction, and a central axis and plural elastic arms located along the circumferential direction, each of the elastic arms including a connecting portion directly extending forwards from the ring base and a contacting portion directly extending forward from the connecting portion and protruding inwards in the radial direction, wherein the plural elastic arms are composed of first elastic arms and second elastic arms located alternately in the circumferential direction, and the connecting portions of the second elastic arms are located closer to the central axis than the connecting portions of the second elastic arms in the radial direction.

### BACKGROUND OF THE INVENTION

### Field of the Invention

The present invention relates to a cable connector with improved conductive terminals.

### Description of Related Arts

U.S. Publication No. 20230111635 A1 discloses a floating socket connector with a contact. The contact is formed from a ring-like connecting portion having a plurality of separate flexible beams cantilevered therefrom.

### SUMMARY OF THE INVENTION

An object of the present invention is to provide a cable connector with improved conductive terminals.

To achieve the above-mentioned object, a cable connector comprises: an insulating shell; two conductive members each having a receiving hole opening forwards and connecting with a cable respectively; and two conductive terminals assembled in the receiving holes respectively, each conductive terminal comprising a ring base defining a circumferential direction, a radial direction, and a central axis and a plurality of elastic arms located along the circumferential direction, each of the elastic arms comprising a connecting portion directly extending forwards from the ring base and a contacting portion directly extending forward from the connecting portion and protruding inwards in the radial direction, wherein the plurality of elastic arms is composed of first elastic arms and second elastic arms located alternately in the circumferential direction, and the connecting portions of the second elastic arms are located closer to the central axis than the connecting portions of the second elastic arms in the radial direction.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of an electrical connector assembly of an embodiment of the present application, including a cable connector and a board connector disconnected from each other;

FIG. 2 is an exploded perspective view of the cable connector in FIG. 1;

FIG. 3 is a perspective view of a half of the conductive terminal in FIG. 2;

FIG. 4 is a perspective view of the conductive terminal in FIG. 2;

FIG. 5 is another perspective view of the conductive terminal in FIG. 4;

FIG. 6 is a partial exploded perspective view of the cable connector in FIG. 1;

FIG. 7 is another view of FIG. 6; and

FIG. 8 is another perspective view of the board connector in FIG. 1.

### DETAILED DESCRIPTION OF THE PREFERRED EMBODIMENT

Reference will now be made to the drawing figures to describe a preferred embodiment of the present invention in detail.

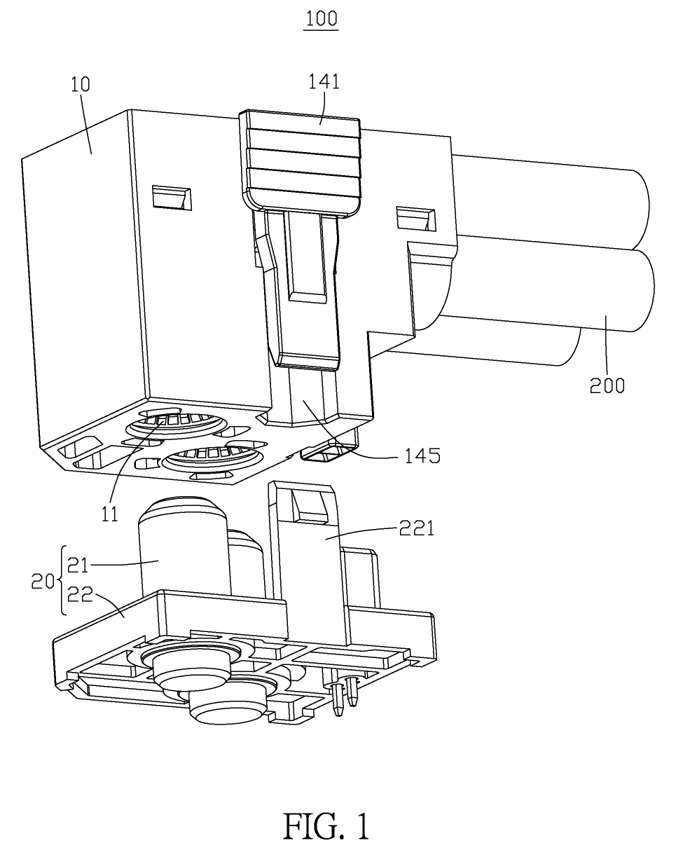

Referring to FIGS. 1-8, an electrical connector assembly 100 of an embodiment is illustrated, and the assembly is capable of transmitting high current above 10A. Refer to FIG. 1, the electrical connector assembly 100 includes a cable connector 10 and a board connector 20. The cable connector 10 is configured to connect with cables 200, and the board connector 20 is configured to connect with a circuit board (not shown). The board connector 20 is adapted to mate with the cable connector 10. The board connector 20 includes two conductive posts 21 and an insulating base 22 retaining the conductive posts 21, the conductive posts 21 are configured to mate with and removed from conductive terminals 11 of the cable connector 10.

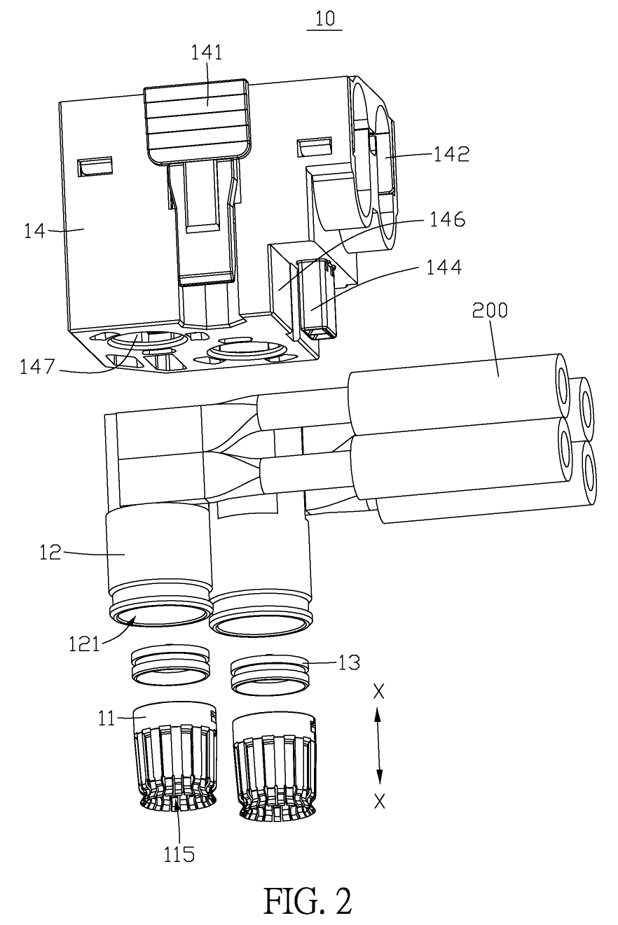

Refer to FIGS. 2 to 5, the cable connector 10 includes two conductive terminals 11 and two conductive members 12. The conductive terminal 11 contact with the conductive member 12 to form an electrical connection, and the conductive member 12 is configured to connect with the cable 200. The conductive member 12 has a receiving hole 121, and the conductive terminal 11 is received within the receiving hole 121. The conductive posts 21 are inserted into or removed from the conductive terminals 11 in a front-rear direction X-X or a mating direction as shown in FIG. 2.

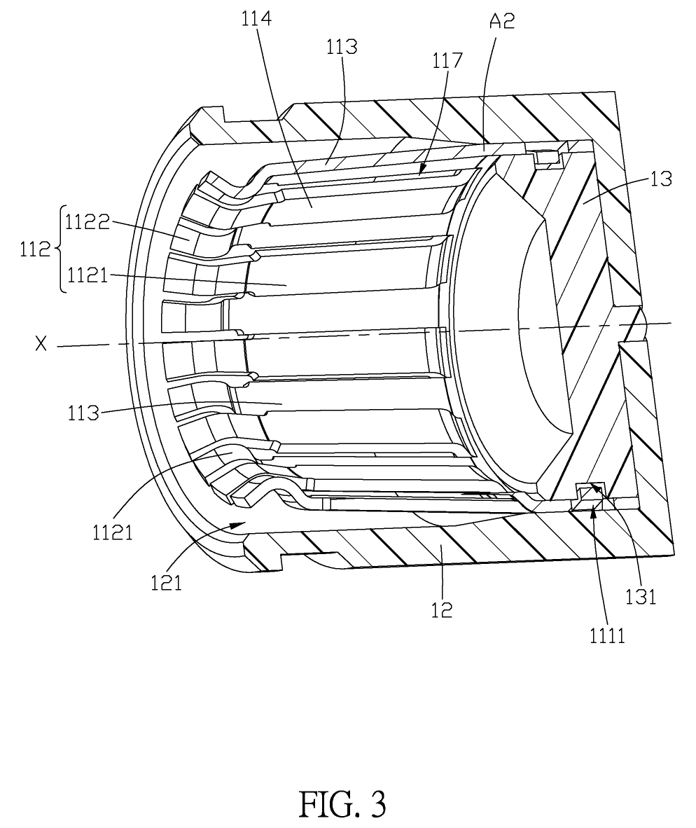

Refer to FIGS. 3 to 5. the conductive terminal 11 includes a ring base 111 and a plurality elastic arms 112. The ring base 111 is configured as an annular structure and is connected to the conductive member 12 in the receiving hole 121 to achieve the connection between the conductive terminal 11 and the conductive member 12. The ring base 111 is a circular ring or may also be an elliptical ring, rectangular ring, or other shapes of annular structures. The ring base 111 has a circumferential direction, a radial direction and a central axis X as shown in FIG. 3. The radial direction is perpendicular to the central axis X, the central axis X extends in the front-rear direction X-X.

The elastic arms 112 are distributed circumferentially along the ring base 111, forming a mating space 115. The mating space 115 is configured to allow the conductive post 21 of the board connector 20 to be inserted into. The elastic arms 112 are spaced from an inside of the receiving hole 121, allowing the elastic arms 112 to move in the radial direction, i.e., the elastic arms 112 can move in the radial direction toward or away from the central axis X. The elastic arm 112 includes a connecting portion 1121 and a contacting portion 1122. The connecting portions 1121 are connected to the ring base 111, and the contacting portions 1122 are connected to the front ends of the connecting portions 1121. Seen in the central axis X, a connection point A1 between the connecting portion 1121 and the contacting portion 1122 is closer to the central axis X compared to a connection point A2 between the connecting portion 1121 and the ring base 111. The contacting portions 1122 are configured to move in the radial direction, either away from or closer to the central axis. As shown in the figures, the connecting portions 1121 slantwise extend forwards and inwards, that is, the connecting portions 1121 extend in an inclined direction toward the central axis X.

Understandably, when the conductive post 21 is inserted into the mating space 115, the conductive post 21 presses against the elastic arms 112, causing the elastic arms 112 to undergo elastic deformation. By positioning the contacting portions 1122 at the front ends of the elastic arms 112, the conductive thickness of the cable connector 10 can be increased without changing the overall length of the conductive terminal 11 and meets the requirements of high-current circuits and facilitates the miniaturization of the electrical connection assembly 100.

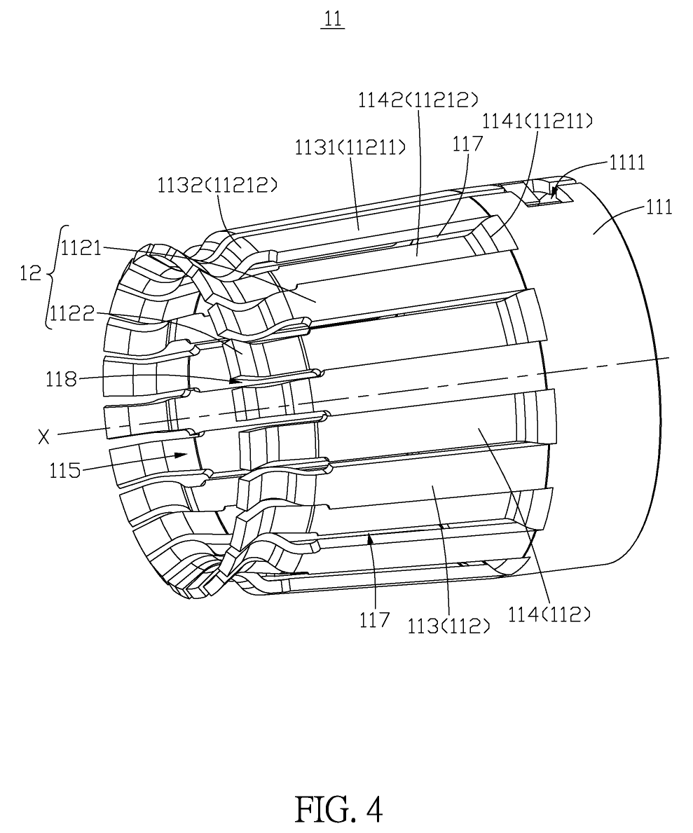

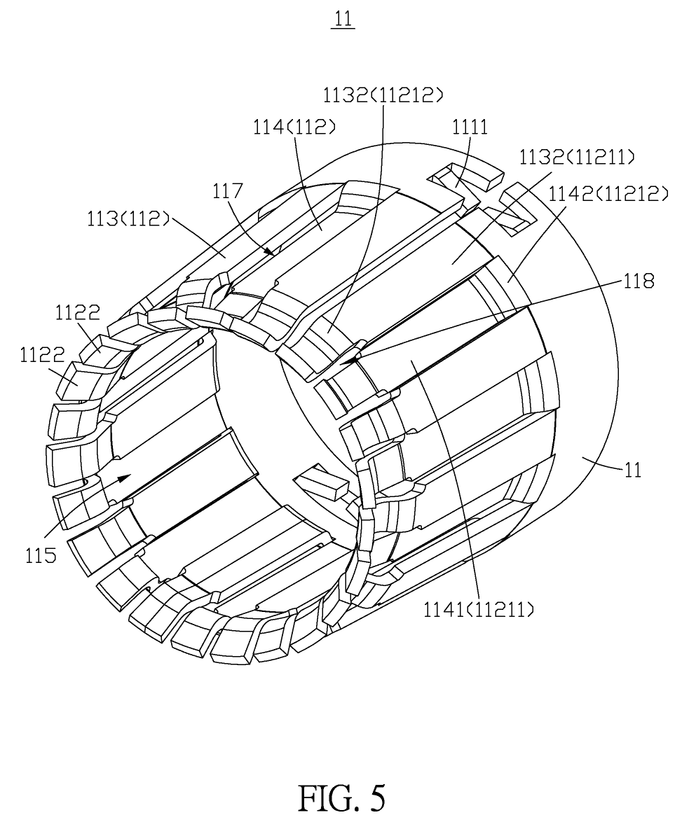

Referring to FIGS. 4 and 5, the plurality of elastic arms 112 includes first elastic arms 113 and second elastic arms 114. The first elastic arms 113 and the second elastic arms 114 are alternately distributed along the circumferential direction, commonly forming the mating space 115. A gap is formed between every two adjacent first elastic arms 113, the second elastic arm 114 is located aligned with the gap respectively while closer to the central axis. That is, the first elastic arms 113 and the second elastic arms 114 are wholly offset from each other in the radial direction. The staggered arrangement of the elastic arms 112 increases the number of elastic arms 112 of the conductive terminal 11, avoiding the waste of the gaps between two adjacent first elastic arms 113 and improving the utilization rate of the conductive terminal 11. Additionally, the connecting points between the conductive terminal 11 and the conductive member 12 also increase to help reduce the resistance of the conductive terminal 11 wholly and to lower the temperature rise of the conductive terminal 11 for meeting the requirements for high-current applications.

Referring to FIGS. 3 to 5, a first clearance gap 117 is formed between the first elastic arm 113 and the second elastic arm 114 in the radial direction. When the board connector 20 is mated with the conductive terminal 11, the first elastic arms 113 and the second elastic arms 114 are pushed by the conductive post 21 and move in the direction away from the central axis. The first clearance gap 117 provides a movement distance for the second elastic arm 114, allowing the second elastic arm 114 to avoid interference with the first elastic arms 113. Therefore, the risk of motion interference between adjacent first elastic arms 113 and second elastic arms 114 is reduced, ensuring the stability and safety of the conductive terminal 11 during use. The elastic arms 112 are formed by punching, and a gap between adjacent elastic arms in the circumferential direction is infinitely close to zero. One elastic arm of every two adjacent elastic arms bends inwardly at a root thereof and then extending forward to form the second elastic arm 114, while another elastic arm of every two adjacent elastic arms extends directly forward to form the first elastic arm 113. This staggered arrangement of the first and the second elastic arms 114 in the radial direction ensures that the first and the second elastic arms do not interfere with each other when the conductive post 21 is inserted. The contacting portion 1122 has an arc-shaped contacting point 11221 protruding inwardly, the contacting points of the first and second elastic arms are located at a same radial position.

Referring to FIGS. 4 and 5, the connecting portion 1121 includes a straight section 11211 and a bent section 11212 connected to the straight section 11211. The straight section 11211 of the first elastic arm 113 is connected to the ring base 111, and the bent section 11212 is connected to the contacting portion 1122. The straight section 11211 of the second elastic arm 114 is connected to the contacting portion 1122, and the bent section 11212 is connected to the ring base 111. The first clearance gap 117 is so formed.

Exemplarily, first straight sections 1131 extend forwards from the base portion 111. The front ends of the first straight section 1131 bends inward to form first bent sections 1132. The contacting portions 1122 arc inward from the first bent sections 1132 respectively. The first bent section 1132 and the first straight section 1131 together form the first elastic arm 113. Second bent sections 1141 bend inwards from the base portion 111 in the radial direction and second straight sections 1142 extend forwards from the second bend section 1141. The contacting portions 1122 arc inwards from the front ends of the second straight sections 1142. The second bent section 1142 and the second straight section 1141 together form the second elastic arm 114.

Referring to FIGS. 4 and 5, the radial distance between the lowest point of the first contacting portion 1122 and the central axis is defined as a first distance L1, and the radial distance between the lowest point of the second contacting portion 1122 and the central axis is defined as the second distance L2, wherein L1 = L2. It should be noted that the lowest point of the contacting portion 1122 specifically refers to the part of the contacting portion 1122 that is closest to the central axis in the radial direction. This lowest point is used to contact the conductive post 21, forming the arc-shaped contacting points of the first and second elastic arms. In this embodiment, the arc-shaped contacting portions of the first and second elastic arms are located at the same radial position. When the board connector 20 is mated with the conductive terminal 11, the first elastic arms 113 and the second elastic arms 114 move outwards synchronously in the radial direction, ensuring that the first clearance gaps 117 in the radial direction of the ring base 111 always exists. Therefore, the risk of interference between adjacent first elastic arms 113 and second elastic arms 114 is further reduced.

In other embodiments, the lowest point of the first contacting portion 1122 in the first elastic arm 113 and the lowest point of the second contacting portion 1122 in the second elastic arm 114 may not be on a same circular line, i.e., L1 ≠ L2. When the board connector 20 is mated with the conductive terminal 11, the first elastic arm 113 and the second elastic arm 114 may move asynchronously. For example, the second elastic arm 114 may move firstly, followed by the first elastic arm 113, or the first elastic arm 113 may move first, followed by the second elastic arm 114.

Referring to FIGS. 4 and 5, a second clearance gap 118 is formed between the first contacting portion 1122 and the second contacting portion 1122 in the circumferential direction. Therefore, the risk of interference between the adjacent contacting portions 1122 is reduced, further lowering the risk of interference between the adjacent first elastic arm 113 and second elastic arm 114. The adjacent contacting portions are formed by blanking, thereby creating the second clearance gap 118. In some embodiments, the ring base 111 and the elastic arms 112 are configured as an integrated structure. Therefore, the structural strength at the connection points between the elastic arms 112 and the ring base 111 is improved, and the production process is simplified. Exemplarily, a circular ring is selected and axially cut using a cutting machine to divide the ring into multiple strip-shaped plate bodies while reserving a portion of the intact ring, i.e., the ring base portion. Subsequently, the strip-shaped plate bodies are bent to form the elastic arms 112. In other embodiments, methods such as casting and molding can also be used. The present application does not limit this, and those skilled in the art can make selections based on actual requirements.

In this embodiment, the conductive terminal 11 is made from a metal strip by a punching method to cut the metal strip and then to bend. The elastic arms are split from each other without any gaps therebetween and terminated at the base, and then the front parts of the elastic arms further are further punched with a gap or a blanking gap at every two adjacent elastic arms and then protrude inwards to forms the contacting portions. Some of the elastic arms are bent to offset from another elastic arms to form the second elastic arms. Last, the metal strip is bent to be a ring shape and extending forwards from the ring base, each of the elastic arms has a contacting portion protruding towards central axis in the radial direction.

Referring to FIGS. 2 and 3, the cable connector 10 includes a fixing member 13. The fixing member 13 is installed within the receiving hole 121 and is connected to the conductive member 12. The fixing member 13 has a first mounting portion 131, and the ring base 111 portion has a second mounting portion 1111. The first mounting portion 131 cooperates with the second mounting portion 1111 to retain the conductive terminal 11 to the fixing member 13. Therefore, the risk of deformation or damage to the elastic arms 112 during the mating process of the cable connector 10 is reduces, thereby improving the installation efficiency of the conductive terminal 11, and enhances the stability of the conductive terminal 11 during installation. In some embodiments, the fixing member 13 is configured to be made of a metallic material to increase current transmission. Alternatively, in some embodiments, the fixing member 13 is configured to be made of an insulating material, which can be used for low-current transmission.

Referring to FIGS. 1 and 2, the cable connector 10 includes an insulating shell 14. The conductive member 12 is installed within the insulating shell 14. The insulating shell 14 has a through hole 142, and the through hole is configured to allow the cable 200 to pass through. The board connector 20 further includes an insulating base 22. The conductive posts 21 are retained on the insulating base 22 and protrude out of the insulating base to form a mating portion which is used to be inserted in the mating space 115. The insulating shell 14 has a locking arm 141, and the insulating base 22 has a locking post 221. When the board connector 20 is mated with the cable connector 10, the locking arm 141 cooperates with the locking post 221 to lock the board connector 20 and the cable connector 10 together, enhancing the stability of the mating between the board connector 20 and the cable connector 10.

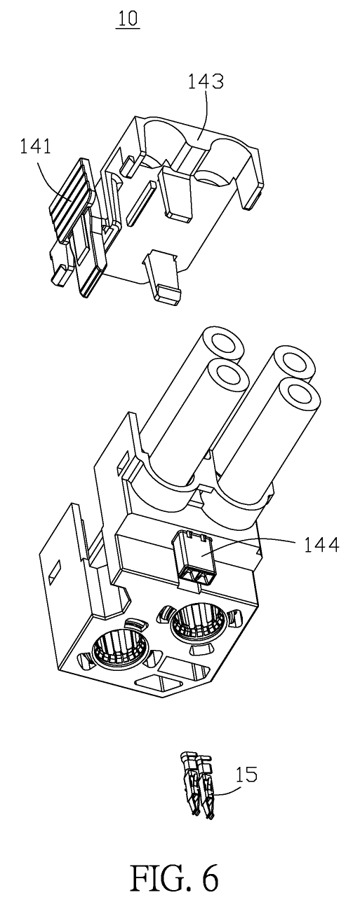

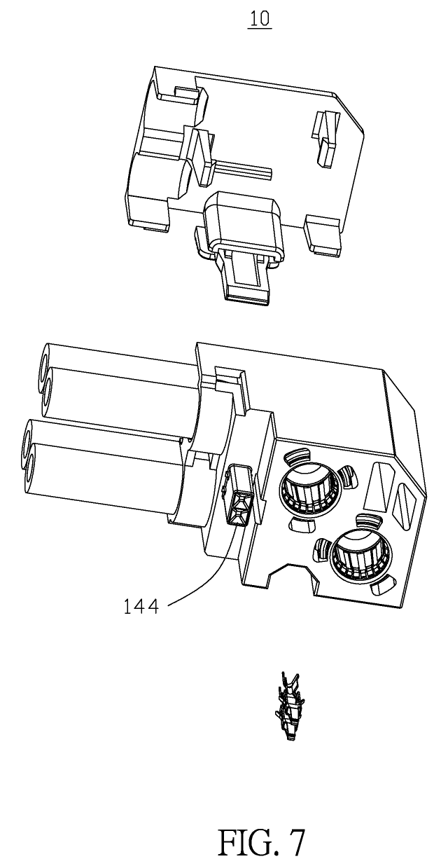

As shown in FIGS. 6-7, the cable connector includes a separate rear cover 143, and the locking arm 141 is integrally formed with the rear cover 143. When the rear cover 143 is assembled onto the insulating shell 14, the locking arm 141 is accommodated in a passage 145 defined on the in the insulating shell 14. The insulating shell 14 includes a signal post 144 extending therefrom, and two signal terminals 15 are retained within signal holes 1441 defined on the signal post 144. The signal post 144 separates from a mating portion 146 of the insulating shell 14. The insulating shell 14 has two holes 147 opening through the mating portion 146, the conductive members are received in corresponding holes 147 respectively. In this embodiment, the signal post 144 is cylindrical and has two signal holes to respectively accommodate the signal terminals 15.

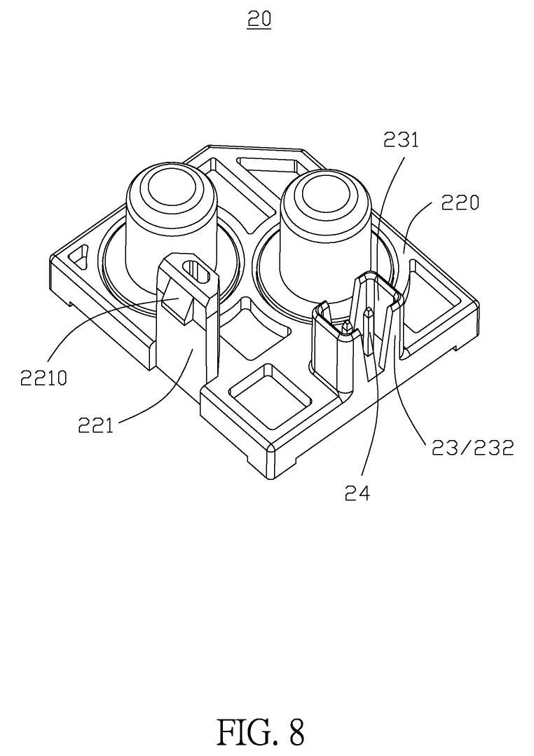

As shown in FIG. 8, the board connector 20 includes a signal frame 23 and the locking post 221, both of which extend upward from a top or mating face 220 of the insulating base 22. The signal frame 23 surrounds the signal terminals 24, and the locking post 221 has an outwardly protruding locking head 2210 at a front end thereof. In this embodiment, the signal frame 23 has a mating cavity 231, and the signal post 144 is accommodated within the mating cavity 231. The pin-shaped signal terminals 24 are inserted into the signal holes of the cable connector. As shown in the figures, the signal frame 23 and the locking post 221 are located at adjacent outer edges of the insulating base 22. The signal frame 23 is formed by two U-shaped enclosing walls 232 arranged facing each other, with a gap between the two U-shaped enclosing walls 232.

The above-mentioned embodiments are only preferred embodiments of the present invention, and should not limit the scope of the present invention, any simple equivalent changes and modifications made according to the claims of the present invention and the contents of the description should still belong to the present invention.

1. A cable connector comprising:an insulating shell;two conductive members each having a receiving hole opening forwards and connecting with a cable respectively; andtwo conductive terminals assembled in the receiving holes respectively, each conductive terminal comprising a ring base defining a circumferential direction, a radial direction, and a central axis and a plurality of elastic arms located along the circumferential direction, each of the elastic arms comprising a connecting portion directly extending forwards from the ring base and a contacting portion directly extending forward from the connecting portion and protruding inwards in the radial direction; wherein the plurality of elastic arms is composed of first elastic arms and second elastic arms located alternately in the circumferential direction, and the connecting portions of the second elastic arms are located closer to the central axis than the connecting portions of the second elastic arms in the radial direction.

2. The cable connector as claimed in claim 1, wherein:the connecting portion of each of the first elastic arms comprises a first straight section extending from the ring base, a first bending section bending inward from the first straight section in the radial direction, the contacting portion of the first elastic arm directly arcs inwards from the first bending section in the radial direction; andthe connecting portion of each of the second elastic arms comprises a second bent section extending inwards from the ring base in the radial direction, a second
straight section extending forwards from the second bending section, the contacting portion of the second elastic arm directly arcs inwards from the second straight.

3. The cable connector as claimed in claim 2, wherein the first straight sections and the second straight sections are offset without any overlap in the radial direction, and the connecting portions of the first elastic arms and the connecting portions of the second elastic arms are split from each other without any gaps in the circumferential direction.

4. The cable connector as claimed in claim 1, wherein the cable connector comprises two fixing members, and the ring base is sandwiched between the fixing member and an inside of the receiving hole.

5. The cable connector as claimed in claim 4, wherein the fixing member is made from metal material and has plural fixing recesses, the ring base has plural fixing tabs, and the fixing tabs are retained in the fixing recesses.

6. The cable connector as claimed in claim 1, wherein the insulating shell comprises a separate rear cover, the rear cover covers the conductive members and parts of the cables, and a locking arm extends from the rear cover.

7. The cable connector as claimed in claim 6, wherein the insulating shell has a passage opening forwards, the locking arm extends along the passage.

8. The cable connector as claimed in claim 1, wherein each of the conductive
members has a flat face behind the receiving hole, the cable is attached on the flat face.

9. The cable connector as claimed in claim 1, wherein the insulating shell has a distinct a signal post extending forwards, the signal post has two holes opening forwards, two signal terminals are received in the holes respectively

10. A conductive terminal comprising:a ring base defining a circumferential direction, a radial direction, and a central axis; anda plurality of elastic arms split from each other in the circumferential direction and extending forwards from the ring base, each of the elastic arms having a contacting portion protruding towards the central axis in the radial direction;wherein the plurality of elastic arms is composed of first elastic arms and second elastic arms located alternately along the circumferential direction, and the second elastic arms are offset from the first elastic arms in the radial direction to avoid interference except the contacting portions.

11. The conductive terminal as claimed in claim 10, wherein:each of the first elastic arms comprises a first straight section extending from the ring base, a first bending section bending inward from the first straight section in the radial direction, the contacting portion of the first elastic arm directly arcs inwards from the first bending section in the radial direction;each of the second elastic arms comprises a second bent section extending inwards from the ring base in the radial direction, a second straight section extending forwards from the second bending section, the contacting portion of the
second elastic arm directly arcs inwards from the second straight; andthe first straight sections and the second straight sections are offset without any overlap in the radial direction.

12. A cable connector comprising:two conductive members each having a receiving hole opening forwards;two conductive terminals received in corresponding receiving holes;cables connecting with corresponding conductive members respectively;two signal terminals; andan insulating shell having a mating portion and a signal post, the mating portion having two holes receiving corresponding conductive members respectively, the signal post having two signal holes receiving corresponding signal terminal respectively;wherein the signal post separates from the mating portion.

13. The cable connector as claimed in claim 12, wherein the cable connector comprises a separate rear cover assembled to the insulating shell and a locking arm extending from the rear cover.

14. The cable connector as claimed in claim 13, wherein the insulating shell has a passage, and the locking arm extends along the passage.
